(19) United States
(12) Patent Application Publication
(10) Pub. No.: US 2022/0343739 A1
(43) Pub. Date: Oct. 27, 2022

(54) Kingo shopping Device

(71) Applicant: Hajer Aouissi, Granger, IN (US)

(72) Inventor: Hajer Aouissi, Granger, IN (US)

(21) Appl. No.: 17/241,105

(22) Filed: Apr. 27, 2021

Related U.S. Application Data
(60) Provisional application No. 63/178,557, filed on Apr. 23, 2021.

(51) Int. Cl. G07G 1/10; G07G 1/00

(52) U.S. Cl. CPC G07G 1/10; G07G 1/0081; G07G 1/0027

(57) ABSTRACT

Kingo shopping device is an improvement of delivery services consist of an outdoor digital delivery box able the consumers receives automatically their orders, goods and packages more easily and securely in a presentable manner through specific easy new method let the delivery team scan the goods purchased receipt and drop the packages securely into the device. This new smart futures of this device characterized by the cash and certified check payment and the wireless WiFi mode permit the consumers enjoy receiving orders in proper presentable manner with absolutely consumer time free.

### TECHNICAL FIELD

Kingo shopping device is an invention relates to the technology filed and more particularly is an improvement of the methods of digitize delivery services and modernization of distribution solutions for longer consume goods and services merely for functional satisfaction.

The fact from what we have seen the consumers dramatically experienced during the pandemic of Cov-19 in the same field; Kingo shopping device is a theme of high-tech evolution invention revolutionary product uniquely realize the best definition of new demonstration of modernization of delivery services as time counts in our days simply this automatic smart delivery device is the best improvement of the lack of easy delivery ways.

### BACKGROUND

Kingo shopping device is new modern product for the market facilitate the life of consumers and reflect comfortable consumption; consumers will enjoy assure casual needs on time in easy way using this new modern delivery standards. This invention device will assure the receive of the purchased goods in presentable, formal and safe manner; consumer purchase goods, make orders from all different markets and all sectors without exceptions; grocery stores, restaurants, jewellery, mall, etc. . . . and will be received formally anytime in proper terms consumers will not find their orders anymore on the floor as well will not worries keep waiting for the arrival of the delivery team if they picked to pay cash or with certified check. This device significantly avoid waste of time by avoiding wait in long lines or in front stores for pick up packages due to the busy life circumstances especially during holidays and in especial occasions.

Kingo shopping device is a public product for the whole society; this smart delivery box device is primarily permanent improvement solution for everyone from ordinary person to the biggest markets, multi-firms, stores, outlets, etc. . . . person or a group who intends to receive; orders or purchased goods, products and similar needs. This smart delivery box device it can be attached to any physical Locations; generally, attached to any wall of structure or group of structures where consumers spend their time it can be their homes, offices, or workplaces, local stores, restaurants, manufactures, hotels, etc. . . . depends on costumers choices and preferences and attached in different positions; at the front of the structures by the doors, by the corners or at the back of their structure; yards, gardens, etc. . . . since smart delivery box device can hold any kind of products, orders, goods or packages; food, Clothing, Supplies, etc. . . . this device comes with different sizes and from inside it comes with shelves for better organization or without depending the consumers preferences; this invention is a smart device for anytime and anywhere depending different market needs; rent it, own it as clients wants perfectly assure efficient delivery way with flexibility, safety warranties and in timely manner with smart futures.

Kingo shopping device is the first inclusive delivery box consisting of the wireless WiFi feature in delivery units system. The inclusion of the WiFi wireless feature into the device develop the delivery system smart futures and digitalize the delivery services.

Shopping device by comprising of the inclusion of the wireless WiFi future enlarge advance advantages for digitize the delivery system; consumers gain enormous of special smart futures the fact this device can connect to other smart devices such as computers (laptops and desktops), mobile devices (smart phones and tablets), and other equipment able it to be managed digitally;

Kingo shopping device is definite the importance concept of compatible device drive in the major other high-tech market futures standards resulting a competence of adopting integration of technologies;

This device can interface with near future; as interact with digital signage by adapting visual audio display show greetings and confirmation scripts messages of receiving delivered purchased goods; “Hello”, “delivery accepted”, “Thank you” and alike, as well interact with voice recognition technology to unlock the door of the device automatically and alike.

Reinforced with USB port additionally to the main services functions of the device permit realize additional multiple futures for the consumers; use the device in offline mode or for other purposes like connect or charge smart devices and alike.

Kingo shopping device is in addition providing technological smart futures also primarily assure consumer time free by befitting the consumers with a cash and certified check mode payment futures avoid the waist of the time of consumers who choose to pay cash or by certified check instead other digital different mode of payments so now there is no reason to keep waiting for the delivery team anymore to pay them, this device offer a secure place to hold the cash money and certified check and still received the packages on time just by putting the cash money or the check in the drawer and the delivery team get it when they drop the packages anytime.

Kingo shopping device is a magnificent improvement revolution innovation facilitate the circuits of digitized distribution and modernization commercialization services since this device invention is characterized by the assurance of continue liaison with automatism in distribution field once this device connect via wireless WIFI with robots (flying robots, driving robots, . . . etc) provide enormous booster distribution functions futures for next generation in the future.

Generally, as such many are experimenting with various methods of achieving associated with the same field industry in general, the following is a list of the intrinsic advantages of this invention and a few disadvantages of ordinary delivery ways;
1. From the simple ordinary delivery ways known in our days to the robotic delivery ways expected in the future no one of all this delivery products on the market provide the service of an automatic delivery device accept cash payment or certified checks in fact uniquely this smart delivery box provide this service.
2. This invention realize the best definition of consumer time free due the enrichment of variety of mode payments that treat all consumers choices. Shopping device is absolutely a demonstration of the concept of avoiding waist of time by defeat the struggle of waiting for the delivery team if the consumers wants use cash money or checks and this variety mode of payment uniquely provided by this invention in delivery field.
3. Other some in the market try to use kind of the main concept of box delivery with lack of smart features and lack of consumer privacy instead this invention primarily a smart delivery device offer enormous easy smart technological futures with a complete respect for consumers privacy in formal presentable manner with secure safe mode in automatic delivery services system.
4. Smart delivery box device is a huge definite benefit product in all ways realize modern high technology services standards futures for individuals consumers alike big markets. The core concept of this product as is directly beneficial for consumer well-being as well purely benefit the progress of economic cycle; automatically automatize the delivery service system in the distribution field significantly benefit the commerce and marketing fields as well.
5. In addition of high-tech continue liaison technology system (this device can via wireless connect with robots in the future.

### BRIEF DESCRIPTION OF DRAWING

Note: For simplicity of illustration common cycling industry hardware are not depicted as they are know to those with skill in the art.

This drawing is shown purely for illustrative purposes and not intended capture all embodiment of the invention disclosed.

FIG. 1 is the front side view of the shopping device Show all the embodiment enhanced details of this invention;

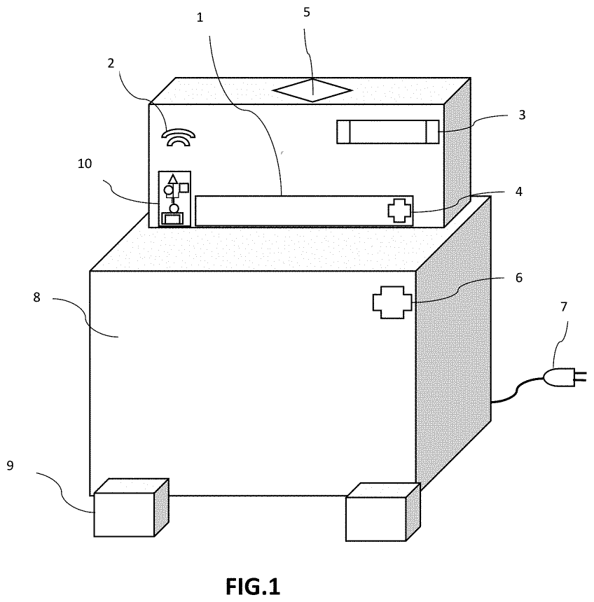

Kingo shopping device is relatively young generally comprise of an attachment of two parts as described in the prior art front view side of the smart delivery box device FIG. 1; the top part of the device having a cash drawer properly attached and connected automatically to both the wireless scanner reader and the base main delivery box door. Once the delivery team scan the receipt of the merchandise automatically the cash drawer door will open and the delivery box door locker will be unlock and allows to drop off the packages and get the cash money or the certified checks safely.

Reference to prior FIG. 1. part 8 is base main part of the smart delivery box device consisting of a box container holder criticized of uniquely a metallic outdoor weatherproof box with an interior covered with thick weather rubber insulation sponge foam roll that assure the safety of all different kind of products and prevent it from damages.

Smart delivery box device is smart delivery box device accomplished with wireless WIFI for best easy functionality, it is included uniquely for connect with parts of the device also to connect the device with other smart devices such as computers (laptops and desktops), mobile devices (smart phones and tablets), and other equipment.

FIG. 1 perspective part 1 illustrate an embodiment of a cash drawer; this cash drawer can holds cash payments received from clients and is used to make change or put tips.

FIG. 1 perspective part 2 illustrate an embodiment of a wireless WIFI that allows device to interface with the Internet and connect an automatic miscellaneous circuits in the device.

FIG. 1 perspective part 3 illustrate an embodiment of a wireless scanner reader; is a simple scanner reader, an optical scanner window that emits light to can read printed bar codes. Reader does not only scan QR Codes, it also scans various types of cards too such as Consumer ID number.

FIG. 1 perspective part 4 illustrate an embodiment of a manual cash drawer locker

FIG. 1 perspective part 5 illustrate an embodiment of a consumer ID number

FIG. 1 perspective part 6 illustrate an embodiment of a manual delivery box door locker

FIG. 1 perspective part 7 illustrate an embodiment of a power input; the amount of energy put into the device.

FIG. 1 perspective part 8 illustrate an embodiment of a weatherproof drop box consist of a box container holder criticized of uniquely a metallic weatherproof box having an interior specially covered with thick weather rubber insulation sponge foam roll to assure the safety of all different kind of products received and prevent it from damages.

FIG. 1 perspective part 9 illustrate an embodiment of an attachment of solid thick magnetic stand support cubic core.

FIG. 1 perspective part 10 illustrate an embodiment of a USB port that establishes specifications for cables and connectors and protocols for connection, communication and power supply between computers, peripherals and other equipment and alike.

### DETAILED DESCRIPTION

The various embodiment and variations thereof illustrated in the accompanying figures and described herein are merely exemplary and are not meant to limit the scope of the invention. It is to be appreciated that numerous variations of the invention have been complemented as would be obvious to one of ordinary skill in the art with benefit of this disclosure.

Rather, the scope and breadth afforded this document should only be limited by the claims provided herein while applying either the plain meaning to each of the terms and phrases in the claims or the meaning clearly and unambiguously provided in this specification.

An embodiment of Smart delivery box device is referring primarily to FIG. 1 illustrated all the embodiment methods is generally comprising;

FIG. 1 perspective part 5 consist of the consumer ID number indicated at the high top center part of the device; this identification number of each client a unique string of characters that identifies the product.

FIG. 1 perspective part 3 Characterized of an embodiment of a wireless scanner reader installed at the top front right side view of the front head device permit scan the merchandise receipt and related automatically to an embodiment of a cash drawer situated between the embodiment of the wireless scanner reader and the embodiment of the wireless WiFi just positioned at the center front view of the head device as shown relatively in FIG. 1 perspective part 1 for best functionality holds the cash and checks payments received from clients.

Just at the opposite side of the head device at the up left corner, according primarily to FIG. 1 perspective part 2 an embodiment consist of a wireless WIFI commonly used to interface the device with a network works via different wireless protocols basically allows an automatic miscellaneous circuits be connected; the wireless WIFI allows the connection of the wireless scanner reader that permit scan the merchandise receipt and once the merchandise receipt is scanned it generate a jointly automatic mechanism unlock reaction for both the cash drawer door and the delivery box container door in the main time let the delivery team drop the packages and get their cash or check payment.

FIG. 1 perspective part 8 relatively consist of an embodiment of a base of a weatherproof metallic box characterized by an interior covered with thick weather rubber insulation sponge foam roll assure permanent safety atmosphere for all different kind of products and prevent it from damages.

This innovatory of presentable smart delivery box device comprise a specific manual futures for the consumers referring mainly to FIG. 1 perspective part 4 an embodiment of a manual cash drawer door locker issued on the center right side of the cash drawer door and an embodiment of a manual delivery box door locker too positioned on the up right corner of the embodiment of the metallic weatherproof box as described in FIG. 1 perspective part 6; this relevant manual technique is for the consumers if they want to unlock the device manually rather than automatically scan their receipts or for an additional option in case of electricity shutdown.

FIG. 1 perspective part 7 comprise an embodiment of a power input issued at the back bottom of the device as illustrated commonly utilized to provide the amount of energy put into the device.

FIG. 1 perspective part 9 illustrate an embodiment show the front view side consist of two solid thick magnetic stand support cubic core. In total the device hold four solid thick magnetic stand support cubic core attached symmetrically at the bottom of the device and located at the opposite ends of the device.

This exemplary drawing of the attachable stand support on the device is just additional complimentary decorative plus give the device special design complete look like baby robot image transitionally distinct this device from different normal ordinary delivery traditional image of delivery drop boxes and eliminate the concept of the old design of a delivery drop box look like a bin placed on the floor.

In conclusion this full embodiment drawing as shown in FIG. 1 give a new future design taste; reflect the taste of a modern image match with our lifestyle, a new modern design of new delivery service include high standards futures system.

FIG. 1 perspective part 10 illustrate an embodiment of a USB port situated at the front left side view of the top part of the device just next to the cash drawer indicated in FIG. 1 perspective part 1 reinforce the main services functions of the device with additional futures for the consumers; use the device for multiple purposes like connect or charge smart devices, connect with the near high-tech futures and alike.

### TERMENOLOGIE

The term “Consumer” as used in the specification and the appended claims refer to “customer”, “client” mean a person or a group who intends to order, orders, or uses purchased goods, products, or services primarily for personal, household, family, social and similar market demand.

The term “etc” (abbreviation) as used in this specification context intended to have the meaning of “others of the same type”. Reference in the specification to the “embodiment” mean that a particular feature, structure or characteristic described essential elements of the invention.

There are hundreds of tiny components associated with the cycling industry that are so common as to be redundant and therefore are included from the description herein; items such as; code scanner, WIFI signal details, automatic door system and the like. Those individuals with ordinary skill in the art with the benefit of this disclosure can from the descriptions provided herein easily and obliviously understand and determine exactly what is required to manufacture assemble or buy items not shown.

The invention claimed is:

1. Kingo shopping device is comprising: a. a metallic weatherproof box at the base of the delivery box device consisting primary of a container holder covered with thick weather rubber insulation sponge foam roll from inside, b. a wireless WIFI located at the left front top part of the device utilized to interface the device via internet allows the connection of the device components also permit the device connect with other smart devices, c. a wireless scanner reader positioned at the right corner on the front top part of the device scan the merchandise receipt, d. a cash drawer on the top of the metallic weatherproof box situated between the wireless WIFI wireless and the scanner reader at the center of the front top part of the device holds the cash payments received from clients, e. a wherein a manual cash drawer locker issued on the right center front side of the cash drawer door as well a delivery box locker on the up right corner side of the door of the base part box device both are unlocked with the same manual method a unique key provided to the consumers, f. a further on the high top surface of the top box device at the center a consumer ID number with unique number or string of characters that identifies the product, g. a power input on the back side of the device that empower the device with the amount of energy, H. a solid thick magnetic stand cubic core attached at the bottom symmetrically and located at the opposite ends of the device reflect significantly the new lifestyle Delivery Systems units, I. a USB port that establishes several common connection specifications.

2. A Kingo shopping device is according to claim 1 Wherein a weatherproof drop box having an interior base with thick weather rubber insulation sponge foam roll from inside provide a unique drop box that assure the safety of the goods purchased once is delivered in presentable secure manner.

3. A Kingo shopping device according to claim 1 Further characterized by the presence of cash drawer future make this invention absolutely the first smart automatic device accept secure cash or certified checks mode payment in delivery services.

4. A Kingo shopping device according to claim 1 Further comprising the cash drawer make this invention absolutely provide a consumer time free the fact it can assure the delivery of the goods purchased even during the absenteeism of the consumer.

5. A Kingo shopping device according to claim 1 Wherein consist of the wireless WiFi is a special smart future included in this invention provide a significant continue liaison of high technology system for inbound and outbound numerous smart futures.

6. A Kingo shopping device according to claim 1 Further comprising USB port offer more variety of connectivity futures for the device with other smart devices if is not plug into any other power source.
